(19) United States
(12) Patent Application Publication
(10) Pub. No.: US 2014/0370212 A1
(43) Pub. Date: Dec. 18, 2014

(54) PACKAGING FILM WITH SUPERIOR SEAL, BARRIER, AND FLEX CRACK RESISTANCE

(71) Applicant: Prolamina Midwest Corporation, Westfield, MA (US)

(72) Inventors: Seyed Hesamoddin Tabatabaei, Montreal (CA); Jeffrey P. Sesolak, Greenville, WI (US)

(21) Appl. No.: 13/918,310

(22) Filed: Jun. 14, 2013

(51) Int. Cl. B65D 65/40; B29C 47/06

(52) U.S. Cl. CPC B65D 65/40; B29C 47/065
USPC 428/34.8; 428/349; 428/335; 264/173.16; 156/244.11

(57) ABSTRACT

A packaging film having enhanced barrier properties, sealability, and flex-crack resistance characteristics and is ideal for use in packaging of food products, such as chunk cheese, to increase shelf life thereof.

### BACKGROUND

Embodiments of the present inventive concept relate to packaging and, in particular, to a packaging film having enhanced barrier, sealability, and flex-crack resistance characteristics and is ideal for use with food products, such as cheese and meat, to increase shelf life thereof.

Flexible packaging, particularly for food, is subject to many demands. The packaging needs to be workable in such a way that the packaging material may be quickly placed around the item to be packaged using machinery. The packaging material must also be of such a quality that it adequately stores the product before the packaging is opened. In the case of food products, this typically means that the packaging materials provide an oxygen barrier to maintain freshness. A widely used structure for packaging chunk cheese is a film laminate is Polyethylene Terephthalate (PET) Polyvinylidene Chloride (PVDC) coated/Poly/Oriented Polypropylene/Ethylene Vinyl Acetate (EVA) seal layer described in U.S. Pat. No. 7,504,142 to Harvey. Although this structure has good stiffness, barrier and seal characteristics, environmental concerns over the use of PVDC exist due to its halogen content.

Accordingly, there is a continuing need for improved packaging and a method of making the same that provides superior sealing, barrier, flex crack and puncture resistance without the environmental concerns of PVDC.

### SUMMARY

The following brief summary is provided to indicate the nature of the subject matter disclosed herein. While certain aspects of the present inventive concept are described below, the summary is not intended to limit the scope of the present inventive concept. Embodiments of the present inventive concept provide a packaging film and method that does not suffer from the problems and limitations of conventional packaging such as those previously discussed.

Embodiments of the present inventive concept provide a packaging film having enhanced barrier, sealability, and flex-crack resistance characteristics, and is ideal for use with food products, such as chees, to increase shelf life thereof.

In one aspect, a packaging film comprises a barrier layer having a first surface and a second surface opposite the first surface. The barrier layer includes a coextruded multilayer structure having an oxygen barrier core layer effective to limit passage of oxygen through the packaging film. An abuse layer is disposed on the first surface of the barrier layer and is effective to resist flex cracking of the packaging film.

A sealant layer is disposed on the second surface of the barrier layer, the sealant layer configured to provide a hermetic seal upon being heat sealed with a like sealant layer of an aligned packaging film.

In another aspect, a method of manufacturing an oxygen barrier packaging film comprises coextruding a multilayer barrier structure having a first surface and a second surface opposite the first surface. The multilayer barrier layer comprising an oxygen barrier core layer. An abuse layer is attached to the first surface of the multilayer barrier structure and a sealant layer is formed on the second surface.

In yet another aspect, a food package, comprises opposing front and back panels of a polymer packaging film. A barrier layer of the polymer packaging film has a first surface and a second surface opposite the first surface. The barrier layer comprises a coextruded multilayer structure having an oxygen barrier core layer effective to limit passage of oxygen through the packaging film. An abuse layer of the packaging film is disposed on the first surface of the barrier layer, the abuse layer being effective to resist flex cracking of the packaging film. A sealant layer of the packaging film is disposed on the second surface of the barrier layer, the sealant layer configured to provide a hermetic seal upon being heat sealed with a like sealant layer of an aligned packaging film. A hermetic seal is provided between at least a portion of the front and back panels of the polymer packaging film.

Additional aspects, advantages, and utilities of the present inventive concept will be set forth in part in the description which follows and, in part, will be obvious from the description, or may be learned by practice of the present inventive concept.

### BRIEF DESCRIPTION OF THE DRAWINGS

Embodiments of the present inventive concept are described in detail below with reference to the attached drawing figures, wherein:

FIG. 1 is a schematic illustrating a film with a layer structure, in accordance an exemplary embodiment of the present inventive concept.

The drawing figure does not limit the present inventive concept to the specific embodiments disclosed and described herein. The drawings are not necessarily to scale, emphasis instead being placed upon clearly illustrating the principles of the present inventive concept.

### DETAILED DESCRIPTION

Detailed embodiments of the present inventive concept are disclosed herein; however, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present inventive concept.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

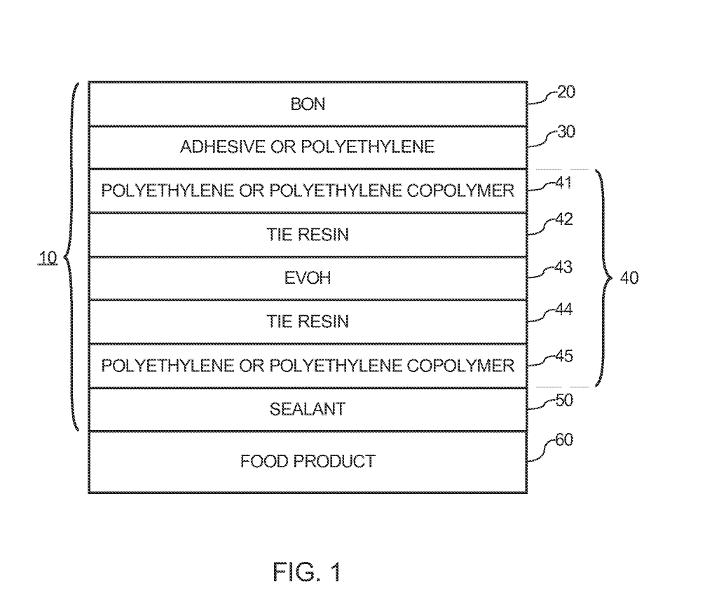

Referring to FIG. 1, a packaging film 10 manufactured in accordance with embodiments of the preset inventive concept is illustrated. The packaging film 10 is configured to be utilized to package a food product 60 and may advantageously be used in connection with the packaging of chunk cheese and is shown and described herein primarily by way of reference thereto. It is to be understood, however, that the packaging film 10 is equally useful for packaging other food products.

For some applications, such as for chunk cheese and others, a packaging film with superior sealability (i.e., the ability to obtain a hermetic seal at a high packaging speed), enhanced oxygen barrier (to increase the shelf life of the product 60) and excellent flex crack resistance (to eliminate creating pin holes during packing process and during transportation) is required. In order to achieve all these requirements, the multilayer laminated film 10 in accordance with this disclosure was developed. The multilayer film 10 comprises a first, abuse layer 20, a second, adhesive layer 30, a third, barrier layer 40 and a fourth, sealant layer 50. The structure of an exemplary embodiment of the packaging film 10 is as follows:

BON—Adhesive or Polyethylene—Polyethylene or Polyethylene Copolymer/Tie/EVOH/Tie/Polyethylene or Polyethylene Copolymer—Polyethylene Copolymer Sealant

wherein a “-” is used to indicate layers that are separately formed and attached and “/” is used to indicate layers that are coextruded with one another.

The first layer 20 comprises an abuse layer which provides a moisture barrier to the packaging film 10 and is disposed on the exterior side of the packaging film which does not contact the food product 60. The abuse layer 20 is preferably made of a biaxially oriented nylon film, preferably 36 to 80 gauge biaxially oriented nylon, which has been found to provide excellent flex crack resistance. In this manner, the thickness of the abuse layer 20 comprises at least a fraction of the thickness of the packaging film 10 in its entirety. It is foreseen that the abuse layer 20 may be made of any like material without deviating from the scope of the present inventive concept.

The third layer 40 is a coextruded barrier film having an oxygen barrier layer 43 in the core, which provides an excellent barrier to oxygen between the cheese or other food product 60 and the surrounding environment, thereby enhancing product shelf life. The third layer 40 has a thickness which is a fraction of the thickness of the packaging film 10 and provides a variety of advantages to the packaging film 10, as discussed herein. Preferably, the third layer 40 has a thickness in the range of about 0.8 mil to about 2.0 mil.

The core 43 is preferably made of ethylene vinyl alcohol (EVOH) and has a thickness of a fraction of the thickness of the packaging film 10 in its entirety. It is foreseen, however, that the middle layer 43 may be made of any EVOH or like material without deviating from the scope of the present inventive concept.

The coextruded barrier layer 40 further includes intermediate layers 42 and 44 on opposite sides of the core 43 and outer layers 41 and 45 disposed on the layers 42 and 44, respectively.

The intermediate layers 42 and 44 are bonding or adhesion layers disposed within the coextruded third layer 40 to enhance adhesion between the outer layers 41 and 45 and the core layer 43. The layers 42 and 44 are made of one or more specialized tie resins operable to increase adhesion between the core 43 and the outer coextruded layers 41 and 45. In this manner, the core layer 43 and the outer coextruded layers 41 and 45 are adhered together. Exemplary tie resins which may be employed include anhydride modified resins such as BYNEL® available from E. I. Du Pont de Nemours and Company of Wilmington, Del. It is foreseen, however, that the adhesion layers 42 and 44 may be made of any specialized tie resin(s) without deviating from the scope of the present inventive concept.

The outermost layers 41 and 45 are disposed on the sides of intermediate layers 42 and 44, respectively, opposite the central core 43 and have a thickness which is a fraction of the thickness of the packaging film 10 in its entirety. In preferred embodiments, the outer core layers 41, 45 comprise polyethylene or polyethylene copolymer. In more preferred embodiments, the outer core layers 41, 45 comprise polyethylene having a density between 0.9 to 0.94 g/cm³. It is foreseen, however, that the outer core layers 41, 45 may be made of other like materials without deviating from the scope of the present inventive concept.

The core layer 43 may be extruded from a first extruder. The intermediate layers 42, 44 may be extruded from a second extruder and the outer layers 41, 45 may be extruded from a third and fourth extruders. The intermediate layers (42, 44) and outer layers (41, 45) of the barrier layer 40 may each be split into two layers and directed to either side of the EVOH core layer 43 layer by a feedblock device.

The coextruded barrier film layer 40 is laminated to the abuse layer 20 using an adhesive layer 30 disposed between the abuse layer and the coextruded barrier layer 40. In this manner, the barrier film layer 40 and the abuse layer 20 are adhered together. In the preferred embodiment, the adhesive layer 30 is polyethylene or polyurethane. It is foreseen, however, that the adhesion layer 30 may be made of any other suitable adhesive layer without deviating from the scope of the present inventive concept.

The sealant layer (inner layer) 50 comprises a low seal initiation temperature ethylene copolymer such as ethylene vinyl acetate (EVA) and has a thickness of a fraction of the thickness of the packaging film 10 in its entirety. In the preferred embodiments, the ethylene copolymer has a comonomer content of about 12% or higher. The thickness of the sealant layer 50 is preferably in the range of about 0.8 mil to 2 mil.

The sealant layer is preferably a low seal initiation temperature ethylene copolymer, most preferably an ethylene copolymer having a melt flow index of about 20 g/in or higher. The sealant layer 50 directly abuts the coextruded barrier layer 40 and is adhered to the coextruded barrier layer 40 using an extrusion coating process. The multilayer structure 10 described herein has superior seal characteristics and barrier properties, and shows almost zero pin holes in flex crack testing.

The layers 20, 40, and 50 complement each other by supplementing weaker characteristics of the other. For example, EVOH is an extrudable resin that has excellent barrier properties with respect to oxygen, grease, oil, flavor, and aroma. However, when exposed to humidity levels of 85% or higher, the barrier properties of EVOH degrade. To avoid this degradation, the EVOH is extruded in a multi-layer coextrusion with intermediate and outer layers 42, 44 and 41, 45, respectively, to protect the EVOH from humidity. Likewise, the layers 41-45 are susceptible to stress cracking in some environments; whereas, the abuse layer 20 provides excellent resistance to flex cracking The sealant layer 50 has enhanced seal properties that are significantly higher than that of the barrier layer 40.

In this manner, the packaging film 10 of the present disclosure has enhanced seal characteristics, barrier properties, and flex-crack resistance characteristics and it has been discovered via testing of the packaging film 10 of the present inventive concept that such yields almost zero pin holes in flex crack testing. Thus, the packaging film 10 is particularly ideal for use with and to store the food product 60, which may advantageously be chunk cheese or other food products.

Although the present inventive concept has been described with reference to the preferred embodiments illustrated in the attached drawing figures, it is noted that equivalents may be employed and substitutions made herein without departing from the scope of the present inventive concept as recited in the claims.

Having thus described the preferred embodiments, the invention is now claimed to be:

1. A packaging film comprising:
a barrier layer having a first surface and a second surface opposite the first surface, said barrier layer comprising a coextruded multilayer structure having an oxygen barrier core layer effective to limit passage of oxygen through the packaging film;
an abuse layer disposed on the first surface of the barrier layer, said abuse layer effective to resist flex cracking of the packaging film; and
a sealant layer disposed on the second surface of the barrier layer, the sealant layer configured to provide a hermetic seal upon being heat sealed with a like sealant layer of an aligned packaging film.

2. The packaging film of claim 1, wherein the barrier layer comprises:
a first intermediate layer on a first side of the oxygen barrier core layer and a second intermediate layer on a second side of the core layer opposite the first side of a middle barrier layer; and
a first outer layer disposed on the first intermediate layer and a second outer layer disposed on the second intermediate layer.

3. The packaging film of claim 2, wherein the first and second intermediate layers contain a first material and the first and second outer layers contain a second material.

4. The packaging film of claim 3, wherein the first material is a tie resin and the second material is a polyolefin or polyolefin copolymer.

5. The packaging film of claim 4, wherein the second material is selected from polyethylene or ethylene vinyl acetate.

6. The packaging film of claim 5, wherein the polyethylene density is between 0.9 to 0.94 g/cm³.

7. The packaging film of claim 1, wherein the barrier layer has a thickness of 0.8 mil to 2 mil.

8. The packaging film of claim 1, wherein the oxygen barrier core layer contains ethylene vinyl alcohol.

9. The packaging film of claim 1, wherein the abuse layer contains biaxially oriented nylon.

10. The packaging film of claim 1, further comprising:
an adhesive layer disposed between the abuse layer and the barrier layer.

11. The packaging film of claim 10, wherein the adhesive layer is selected from polyethylene and polyurethane.

12. The packaging film of claim 1, wherein the sealant layer is a low seal initiation temperature ethylene copolymer.

13. The packaging film of claim 12, wherein the sealant layer is a low seal initiation temperature ethylene copolymer having a comonomer content of about 12% or higher and a melt flow index of about 20 g/in or higher.

14. The packaging film of claim 12, wherein the sealant layer is an ethylene vinyl acetate (EVA).

15. A method of manufacturing an oxygen barrier packaging film comprising the steps of:
coextruding a multilayer barrier structure having a first surface and a second surface opposite the first surface, said multilayer barrier layer comprising an oxygen barrier core layer;
attaching an abuse layer to the first surface of the multilayer barrier structure; and
forming a sealant layer on the second surface.

16. The method of claim 15, wherein the abuse layer is attached to the first surface using an adhesive.

17. The method of claim 15, wherein sealant layer is formed on the second surface using an extrusion coating process.

18. The method of claim 15, wherein the multilayer barrier structure includes:
a first intermediate layer on a first side of the oxygen barrier core layer and a second intermediate layer on a second side of the core layer opposite the first side of a middle barrier layer; and
a first outer layer disposed on the first intermediate layer and a second outer layer disposed on the second intermediate layer.

19. The method of claim 18, wherein each of the first and second intermediate layers is a tie resin and each of the first and second outer layers is selected from the group consisting of polyethylene and polyethylene copolymers.

20. The method of claim 15, wherein the oxygen barrier core layer contains ethylene vinyl alcohol.

21. The method of claim 15, wherein the abuse layer contains biaxially oriented nylon.

22. The method of claim 15, wherein the sealant layer is a low seal initiation temperature ethylene copolymer.

23. A food package, comprising:
opposing front and back panels of a polymer packaging film;
a barrier layer of the polymer packaging film having a first surface and a second surface opposite the first surface, said barrier layer comprising a coextruded multilayer structure having an oxygen barrier core layer effective to limit the passage of oxygen through the packaging film;
an abuse layer of the packaging film disposed on the first surface of the barrier layer, said abuse layer effective to resist flex cracking of the packaging film;
a sealant layer of the packaging film disposed on the second surface of the barrier layer, the sealant layer configured to provide a hermetic seal upon being heat sealed with a like sealant layer of an aligned packaging film; and
a hermetic seal between at least a portion of the front and back panels of the polymer packaging film.
